(19) United States
(12) Patent Application Publication
(10) Pub. No.: US 2015/0052903 A1
(43) Pub. Date: Feb. 26, 2015

(54) ALIGNMENT AND MEASURING TOOL FOR A TURBOMACHINE

(71) Applicant: General Electric Company, Schenectady, NY (US)

(72) Inventors: Robert Pankowski, Warszawa (PL); Kamil Bazyli Kaczorowski, Warszawa (PL); Grzegorz Michal Poltorak, Warszawa (PL); Andrzej Jacek Radlicz, Warszawa (PL)

(21) Appl. No.: 14/449,457

(22) Filed: Aug. 1, 2014

(30) Foreign Application Priority Data
Aug. 21, 2013 (PL) P.405107

(51) Int. Cl. F02C 7/20; B23P 19/10

(52) U.S. Cl. CPC F02C 7/20; B23P 19/10
USPC 60/772; 60/798

(57) ABSTRACT

An alignment and measuring tool for turbomachine combustor includes a support member configured and disposed to operatively connect to a combustor casing mounting element having an opening, and an indexing element connected to the support member. The indexing element includes an opening provided with a first recess zone and a second recess zone. A ferrule including an opening is configured and disposed to be positioned across a combustion liner opening. A cap member is supported upon the support member and arranged within the opening of the indexing element. A rod is arranged in the cap member and extends from a first end to a second end through an intermediate portion. The rod includes an adjustable cone member slidingly mounted upon the intermediate portion. The adjustable cones is configured and disposed to nest in the combustor liner opening.

### CROSS-REFERENCE TO RELATED APPLICATION

This application claims the benefit of priority of Polish Application Serial No. P. 405107 filed Aug. 21, 2013, the disclosure of which is incorporated by reference herein in its entirety.

### BACKGROUND OF THE INVENTION

The subject matter disclosed herein relates to the art of turbomachines and, more particularly, to an alignment and measuring tool for a turbomachine.

Gas turbomachines include a compressor portion linked to a turbine portion through a common compressor/turbine shaft and a combustor assembly. An inlet airflow is passed through an air intake toward the compressor portion. In the compressor portion, the inlet airflow is compressed through a number of sequential stages toward the combustor assembly. In the combustor assembly, the compressed airflow mixes with a fuel to form a combustible mixture. The combustible mixture is combusted in the combustor assembly to form hot gases. The hot gases are guided to the turbine portion through a transition piece. The hot gases expand through a number of turbine stages acting upon turbine buckets mounted on wheels to create work that is output, for example, to power a generator, a pump, or to provide power to a vehicle.

### BRIEF DESCRIPTION OF THE INVENTION

According to one aspect of the exemplary embodiment, an alignment and measuring tool for turbomachine combustor includes a support member configured and disposed to operatively connect to a combustor casing mounting element having an opening, and an indexing element connected to the support member. The indexing element includes a substantially planar surface having an opening provided with a first recess zone extending into the substantially planar surface in a first direction and a second recess zone extending into the substantially planar surface in a second direction. The second direction is substantially perpendicular to the first direction. A ferrule including an opening is configured and disposed to be positioned across a combustor liner opening substantially aligned with the opening in the combustor casing mounting element. A cap member is supported upon the support member and arranged within the opening of the indexing element. The cap member includes a central passage. A rod is arranged in the central passage of the cap member. The rod extends from a first end to a second end through an intermediate portion. The rod includes an adjustable cone member slidingly mounted upon the intermediate portion. The adjustable cone member is configured and disposed to nest in the combustor liner opening.

According to another aspect of the exemplary embodiment, a method of measuring alignment of a combustor liner relative to a combustor casing includes connecting a support member to a combustor casing mounting element having an opening, positioning a cap member in a cap member recess formed in the support member, connecting an indexing element including a substantially planar surface having an opening provided with a first recess zone extending into the substantially planar surface in a first direction and a second recess zone extending into the substantially planar surface in a second direction to the support member, passing a rod through a central passage formed in the cap member, positioning an adjustable cone member on the rod, nesting the adjustable cone member in a ferrule provided across a combustor liner opening substantially aligned with the opening in the combustor casing mounting element, shifting the ferrule in the first direction and measuring a distance between the cap member and an outer edge of the first recess zone, shifting the ferrule in the second direction and measuring a distance between the cap member and an outer edge of the second recess zone, and determining an alignment of the combustor liner opening relative to the combustor casing mounting element.

According to yet another aspect of the exemplary embodiment, a turbomachine component includes a combustor casing having an outer surface and an inner surface that defines an interior portion. The combustor casing includes at least one mounting element having an opening that extends through the outer surface to the interior portion. A combustor liner is arranged within the interior portion. The combustor liner includes an opening that is substantially aligned with the opening in the combustor casing. An alignment and measuring tool is connected to each of the combustor casing and the combustor lining. The alignment and measuring tool includes a support member connected to the mounting element and an indexing element connected to the support member. The indexing element includes a substantially planar surface having an opening provided with a first recess zone extending into the substantially planar surface in a first direction and a second recess zone extending into the substantially planar surface in a second direction. The second direction is substantially perpendicular to the first direction. A ferrule including an opening is positioned across the opening in the combustor liner. A cap member is supported upon the support member and arranged within the opening of the indexing element. The cap member includes a central passage. A rod is arranged in the central passage of the cap member. The rod extends from a first end to a second end through an intermediate portion. The rod includes an adjustable cone member slidingly mounted upon the intermediate portion. The adjustable cone member is configured and disposed to nest in the combustor liner opening.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional partial perspective view of a turbomachine including an alignment and measuring tool, in accordance with an exemplary embodiment;

FIG. 2 is a perspective view of the alignment and measuring tool of FIG. 1;

FIG. 3 is a perspective view of an alignment and measuring tool, in accordance with another aspect of the exemplary embodiment; and

FIG. 4 is an exploded view of the alignment and measuring tool of FIG. 3.

The detailed description explains embodiments of the invention, together with advantages and features, by way of example with reference to the drawings.

### DETAILED DESCRIPTION OF THE INVENTION

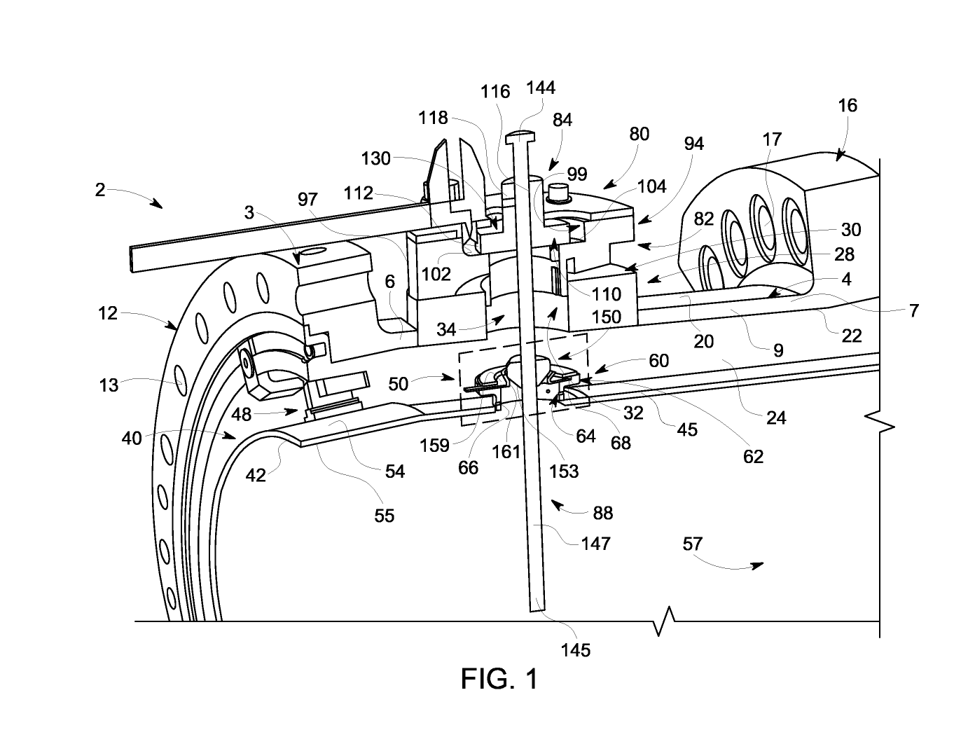

A turbomachine component, in accordance with an exemplary embodiment, is generally indicated at 2, in FIG. 1. Turbomachine component 2 takes the form of a combustor portion 3 including a combustor casing 4. Combustor casing 4 extends from a first end 6 to a second end 7 through an intermediate portion 9. First end 6 includes a first flange 12 having a first plurality of openings 13 and second end 7 includes a second flange 16 having a second plurality of openings 17. First and second pluralities of openings 13 and 17 are configured to receive mechanical fasteners (not shown) that join combustor casing 4 to adjacent structure. Combustor casing 4 includes an outer surface 20 and an inner surface 22 that defines an interior portion 24. Combustor casing 4 also includes a mounting element 28 having a body 30 that extends radially outwardly from outer surface 20. Body 30 includes an opening 32 that extends through outer surface 20 and fluidically connects with interior portion 24. Mounting element 28 may take the form of a spark plug, flame detector, or probe receiving element 34 or other element not having external mounting threads.

A combustor liner 40 is arranged within interior portion 24. Combustor liner 40 extends from a first end portion 42 to a second end portion (not shown) through an intermediate section 45. A liner mounting element 48 is provided on inner surface 22 proximate to first end 6 and first end portion 42. Liner mounting element 48 secures combustor liner 40 to inner surface 22 of combustor casing 4 in a spaced relationship forming a passage 50. Additional liner mounting elements (not shown) are provided on inner surface 22 proximate to first end 6 and first end portion 42 and second end 7 and the second end portion of combustor liner 40. Combustor liner 40 includes an outer surface 54 and an inner surface 55 that defines an inner flow path 57. Combustor liner 40 is also shown to include a mounting member 60 having a body 62 including an opening 64. Mounting member 60 may take the form of a spark plug, flame detector or probe receiving member 66 or the like. Mounting member 60 includes a peripheral, annular slot 68. It is desirable to align opening 32 on mounting element 28 with opening 64 in mounting member 60 to reduce wear and tear on spark plugs, flame detectors, and the like.

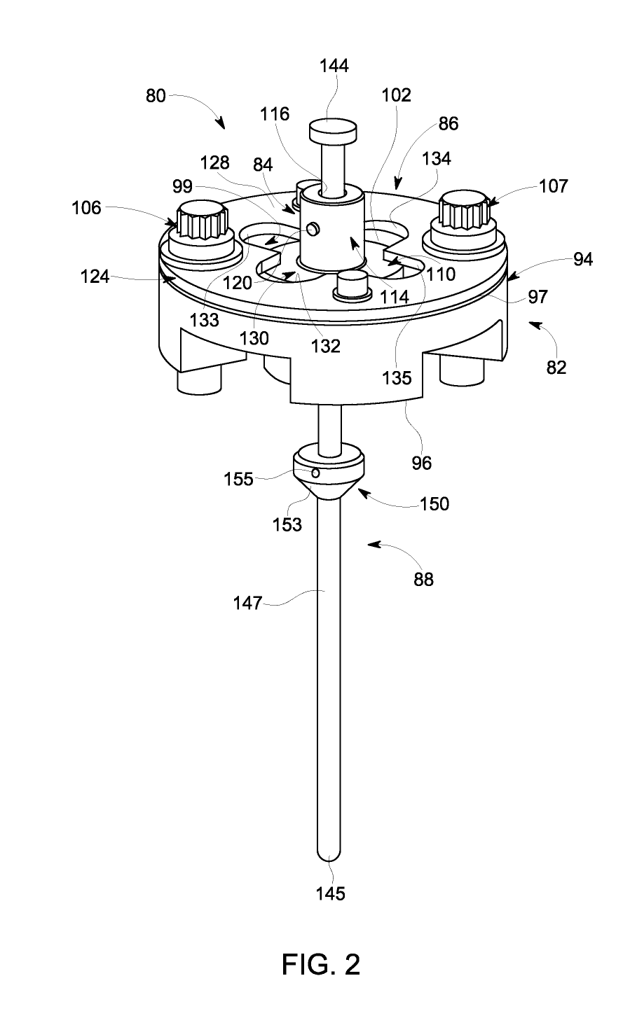

In accordance with an exemplary embodiment, an alignment and measuring tool 80 is employed to determine a relative alignment of mounting element 28 and mounting member 60. As shown in FIG. 2, alignment and measuring tool 80 includes a support member 82, a cap member 84, an indexing element 86 and a rod 88. Support member 82 includes a body 94 that extends from a first support surface 96 to a second, indexing element support surface 97. A recess 99 is formed in body 94 that extends into indexing element support surface 97. Recess 99 includes an annular sidewall 102 (FIG. 1) and a cap member support surface portion 104 (FIG. 1). Body 94 also includes a plurality of fastener member receiving openings (not separately labeled) that provide passage for mechanical fasteners 106 and 107 that join support member 82 to mounting element 28.

Cap member 84 includes a base portion 110 having an outer diametric edge 112 and a post portion 114. Post portion 114 projects substantially perpendicularly from base portion 110. A central passage 116 extends through post portion 114 and base portion 110. Post portion 114 includes a threaded passage 118 that receives a fastener 120 that is configured to be selectively tightened against rod 88. As further shown in FIG. 2, indexing element 86 includes a body 124 having a substantially planar surface 128 provided with a central opening 130. A plurality of fastener receiving openings (not separately labeled) extend through body 124 and align with the plurality of fastener receiving openings in cap member 84. Central opening 130 includes a first recess zone 132, a second recess zone 133, a third recess zone 134 and a fourth recess zone 135. First recess zone 132 extends in a first direction while second recess zone 133 extends in a second direction that is substantially orthogonal to the first direction. Third recess zone 134 extends substantially oppositely from first recess zone 132 and fourth recess zone 135 extends substantially oppositely from second recess zone 133.

Rod 88 extends from a first end 144 to a second end 145 through an intermediate portion 147. Intermediate portion 147 supports an adjustable cone member 150 having a tapered surface 153. Adjustable cone member 150 includes a threaded opening (not separately labeled) that receives a mechanical fastener 155. Mechanical fastener 155 is selectively tightened against rod 88 to secure adjustable cone member 150 in a desirable position along intermediate portion 147. Alignment and measuring tool 80 also includes a ferrule 159 slidingly received in annular slot 68. Ferrule 159 includes an opening 161 that is smaller than opening 64 in mounting member 60.

In accordance with an exemplary embodiment, support member 82 is positioned upon mounting element 28. Cap member 84 is positioned within recess 99 and indexing element 86 is placed on indexing element support surface 97 with post portion 114 extending through central opening 130. Mechanical fasteners (not separately labeled) pass through openings (also not separately labeled) in indexing element 86 and through the fastener member receiving openings in support member 82. The mechanical fasteners engage with mounting element 28 to secure support member 82 and indexing element 86. Rod 88 is passed through central passage 116 and adjustable cone member 150 is installed and positioned. Ferrule 159 is positioned in annular slot 68 of mounting member 60. Rod 88 is manipulated to position tapered surface 153 in opening 161 of ferrule 159.

At this point, ferrule 159 is positioned in a maximum upstream position and a first axial gap between annular sidewall 102 and outer diametric edge 112 is measured through first recess zone 132. Ferrule 159 is shifted axially across opening 64 in the first direction to a maximum downstream position and a second axial gap between annular sidewall 102 and outer diametric edge 112 is measured through third recess zone 134. Ferrule 159 is then positioned in a first maximum radial direction and a first radial gap between annular sidewall 102 and outer diametric edge 112 is measured through second recess zone 133. Ferrule 159 is then shifted radially across opening 64 in the second direction to maximum second radial direction and a second radial gap between annular sidewall 102 and outer diametric edge 112 is measured through fourth recess zone 135. At this point it should be understood that the axial and radial directions are used for exemplary purposes. Ferrule 159 can be shifted in any two orthogonal directions and measurements taken. Once the measurements are taken, an alignment of mounting element 28 and mounting member 60 may be determined in each of the axial and radial directions. Alignment may be determined based on the following equations:

Displacement=GAPₘₐₓ−GAPₘᵢₙ (1)

Alignment=Φ/2−(GAPₘᵢₙ+Displacement/2) (2)
where Φ=the diameter of opening 32
   After determining alignment, combustor liner 40 may be adjusted as necessary to ensure a desired alignment between mounting element 28 and mounting member 60.

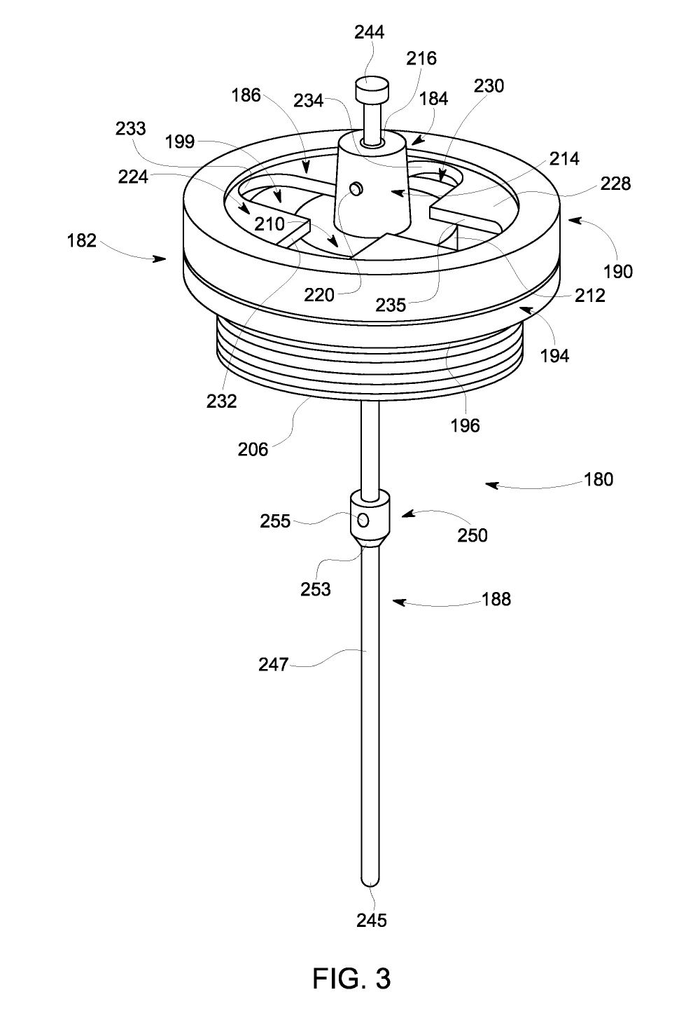

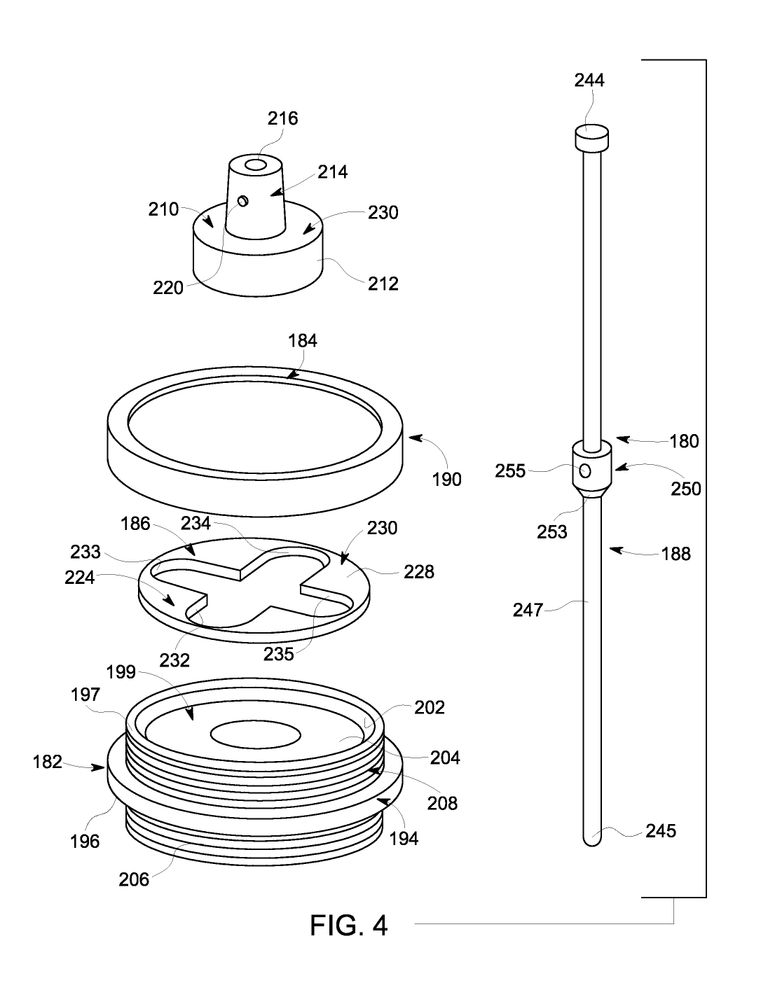

Reference will now be made to FIGS. 3 and 4 in describing an alignment and measuring tool 180, in accordance with another aspect of an exemplary embodiment. As will become more apparent below, alignment and measuring tool 180 is configured for use in combustor casing mounting elements (not shown) having internally threaded openings (also not shown). Alignment and measuring tool 180 includes a support member 182, a cap member 184, an indexing element 186, a rod 188 and an indexing element retaining member 190. Support member 182 includes a body 194 that extends from a first support surface 196 to a second, indexing element support surface 197. A recess 199 is formed in body 194 that extends into indexing element support surface 197. Recess 199 includes an annular sidewall 202 and a cap member support surface portion 204. Body 194 also includes a first threaded region 206 and a second threaded region 208. First threaded region 206 is configured to interface with a threaded mounting element (not shown) on combustor casing 4. At this point it should be understood that while shown with external threads, first threaded region 206 could be configured as internal threads that would engage with an externally threaded mounting element. Second threaded region 208 provides an interface for indexing element retaining member 190.

Cap member 184 includes a base portion 210 having an outer diametric edge 212 and a post portion 214. Post portion 214 projects substantially perpendicularly from base portion 210. A central passage 216 extends through post portion 214 and base portion 210. Post portion 214 includes a threaded passage (not separately labeled) that receives a fastener 220 that is configured to be selectively tightened against rod 188. As further shown in FIGS. 3 and 4, indexing element 186 includes a body 224 having a substantially planar surface 228 provided with a central opening 230. Central opening 230 includes a first recess zone 232, a second recess zone 233, a third recess zone 234, and a fourth recess zone 235. First recess zone 232 extends in a first direction while second recess zone 233 extends in a second direction that is substantially orthogonal to the first direction. Third recess zone 234 extends substantially oppositely from first recess zone 232, and fourth recess zone 235 extends substantially oppositely from second recess zone 233.

Rod 188 extends from a first end 244 to a second end 245 through an intermediate portion 247. Intermediate portion 247 supports an adjustable cone member 250 having a tapered surface 253. Adjustable cone member 250 includes a threaded opening (not separately labeled) that receives a mechanical fastener 255. Mechanical fastener 255 is selectively tightened against rod 188 to secure adjustable cone member 250 in a desirable position along intermediate portion 147. Alignment and measuring tool 180 also includes a ferrule (not shown) slidingly received in another combustor liner mounting member (also not shown). Alignment and measuring tool 180 may be used to determine alignment of mounting elements and mounting members, as discussed above.

At this point, it should be understood that the exemplary embodiments describe tools that can be used to determine alignment between various orifices in a combustor casing and a combustor liner to reduce wear and tear on corresponding devices, probes and the like. It should also be understood that the alignment and measuring tool may be used to determine alignment between spaced openings, components other than combustor casings, and combustor liners. Moreover, it should be understood that the exemplary embodiments need not be limited to determining alignment of turbomachine components.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An alignment and measuring tool for turbomachine combustor comprising:
a support member configured and disposed to operatively connect to a combustor casing mounting element having an opening;
an indexing element connected to the support member, the indexing element including a substantially planar surface having an opening provided with a first recess zone extending into the substantially planar surface in a first direction and a second recess zone extending into the substantially planar surface in a second direction, the second direction being substantially perpendicular to the first direction;
a ferrule including an opening configured and disposed to be positioned across a combustor liner opening substantially aligned with the opening in the combustor casing mounting element;
a cap member supported upon the support member and arranged within the opening of the indexing element, the cap member including a central passage; and
a rod arranged in the central passage of the cap member, the rod extending from a first end to a second end through an intermediate portion, the rod including an adjustable cone member slidingly mounted upon the intermediate portion, the adjustable cone member being configured and disposed to nest in the combustor liner opening.

2. The alignment and measuring tool according to claim 1, wherein the support member includes a body extending from a first surface to a second, indexing element support surface including a recess having an annular side wall and a cap member support surface portion.

3. The alignment and measuring tool according to claim 2, wherein the cap member is arranged in the recess between the cap member support surface portion and the indexing element.

4. The alignment and measuring tool according to claim 2, wherein the cap member includes a base portion having an outer diametric edge and a post portion projecting perpendicularly outwardly from the base portion, the central passage extending through the base portion and the post portion.

5. The alignment and measuring tool according to claim 4, wherein the post portion includes a threaded passage extending toward the central passage, and a fastener arranged in the threaded passage, the fastener being configured and disposed to selectively constrain movement of the rod relative to the cap member.

6. The alignment and measuring tool according to claim 2, wherein the body of the support member includes at least one fastener receiving opening extending from the indexing element support surface through the first surface, the at least one fastener receiving opening provided with a mechanical fastener configured and disposed to secure the support member to a combustor casing at the combustor casing mounting element.

7. The alignment and measuring tool according to claim 6, wherein the indexing element includes at least one fastener receiving opening aligned with the at least one fastener receiving opening on the support member, the indexing element being secured to the support member through the mechanical fastener.

8. The alignment and measuring tool according to claim 2, wherein the body of the support member includes a first threaded region provided at the first surface and a second threaded region provided at the indexing element support surface, the first threaded region being configured and disposed to threadably engage with the combustor casing mounting element.

9. The alignment and measuring tool according to claim 8, further comprising: an indexing element retaining member threadably engaged with the support member at the second threaded region, the indexing element retaining member clamping the indexing element against the indexing element support surface.

10. A method of measuring alignment of a combustor liner relative to a combustor casing, the method comprising:
connecting a support member to a combustor casing mounting element having an opening;
positioning a cap member in a recess formed in the support member;
connecting an indexing element including a substantially planar surface having an opening provided with a first recess zone extending into the substantially planar surface in a first direction and a second recess zone extending into the substantially planar surface in a second direction to the support member;
passing a rod through a central passage formed in the cap member;
positioning an adjustable cone member on the rod;
nesting the adjustable cone member in a ferrule provided across a combustor liner opening substantially aligned with the opening in the combustor casing mounting element;
shifting the ferrule in the first direction and measuring a distance between the cap member and an outer edge of the first recess zone;
shifting the ferrule in the second direction and measuring a distance between the cap member and an outer edge of the second recess zone; and
determining an alignment of the combustor liner opening relative to the combustor casing mounting element.

11. The method of claim 10, wherein connecting the support member to the mounting element includes securing the support member to a spark plug receiving element formed in the combustor casing.

12. The method of claim 11, wherein nesting the adjustable cone member in the ferrule provided across a combustion liner opening provided across a combustion liner opening includes resting the adjustable cone member in a ferrule provided across a spark plug receiving member.

13. The method of claim 10 wherein connecting the support member to the mounting element includes securing the support member to a probe installation element formed in the combustor casing.

14. The method of claim 13, wherein nesting the adjustable cone member in the ferrule provided across a combustion liner opening includes resting the adjustable cone member in a ferrule provided across a probe receiving member.

15. The method of claim 10, wherein shifting the ferrule in the first direction includes shifting the ferrule in an axial direction and shifting the ferrule in the second direction includes shifting the ferrule in a radial direction.

16. A turbomachine component comprising:
a combustor casing having an outer surface and an inner surface that defines an interior portion, the combustor casing including a mounting element having an opening that extends through the outer surface to the interior portion;
a combustor liner arranged within the interior portion, the combustor liner including an opening that is substantially aligned with the opening in the combustor casing; and
an alignment and measuring tool connected to each of the combustor casing and the combustor liner, the alignment and measuring tool comprising:
a support member connected to the mounting element;
an indexing element connected to the support member, the indexing element including a substantially planar surface having an opening provided with a first recess zone extending into the substantially planar surface in a first direction and a second recess zone extending into the substantially planar surface in a second direction, the second direction being substantially perpendicular to the first direction;
a ferrule including an opening positioned across the opening in the combustor liner;
a cap member supported upon the support member and arranged within the opening of the indexing element, the cap member including a central passage; and
a rod arranged in the central passage of the cap member, the rod extending from a first end to a second end through an intermediate portion, the rod including an adjustable cone member slidingly mounted upon the intermediate portion, the adjustable cone member is configured and disposed to nest in the combustor liner opening.

17. The turbomachine component according to claim 16, wherein the support member includes a body extending from a first surface to a second, indexing element support surface including a recess having an annular side wall and a cap member support surface portion.

18. The turbomachine component according to claim 17, wherein the cap member is arranged in the recess between the cap member support surface portion and the indexing element.

19. The turbomachine component according to claim 16, wherein the cap member includes a base portion having an outer diametric edge and a post portion projecting perpendicularly outwardly from the base portion, the central passage extending through the base portion and the post portion.

20. The turbomachine component according to claim 17, wherein the body of the support member includes at least one fastener receiving opening extending from the indexing element support surface through the first surface, the at least one fastener receiving opening provided with a mechanical fastener configured and disposed to secure the support member to a combustor casing at the combustor casing mounting element and wherein the indexing element includes at least one fastener receiving opening aligned with the at least one fastener receiving opening on the support member, the indexing element being secured to the support member through the mechanical fastener.
